(19) United States
(12) Patent Application Publication
(10) Pub. No.: US 2026/0140361 A1
(43) Pub. Date: May 21, 2026

(54) MIRROR DEVICE AND OPTICAL SCANNING DEVICE

(71) Applicant: FUJIFILM Corporation, Tokyo (JP)

(72) Inventor: Keisuke AOSHIMA, Kanagawa (JP)

(73) Assignee: FUJIFILM Corporation, Tokyo (JP)

(21) Appl. No.: 19/402,214

(22) Filed: Nov. 26, 2025

Related U.S. Application Data
(63) Continuation of application No. PCT/JP2024/016126, filed on Apr. 24, 2024.

(30) Foreign Application Priority Data
May 29, 2023 (JP) 2023-087983

(51) Int. Cl. G02B 26/08; G02B 26/10

(52) U.S. Cl. CPC G02B 26/0858; G02B 26/101

(57) ABSTRACT

A mirror device includes a driving unit that has a plurality of piezoelectric actuators disposed to face each other across a first axis or a second axis, a piezoelectric sensor that generates a signal corresponding to swinging of a mirror portion around the first axis or the second axis, a plurality of metal pads that are formed on a fixed frame, and a plurality of metal wires that electrically connect the piezoelectric actuators and the piezoelectric sensor to the plurality of metal pads. The plurality of metal wires have a shape and a position that are line-symmetrical about the first axis or the second axis except for a contact region in contact with the piezoelectric actuator or the piezoelectric sensor.

### CROSS-REFERENCE TO RELATED APPLICATIONS

This application is a continuation application of International Application No. PCT/JP2024/016126, filed Apr. 24, 2024, the disclosure of which is incorporated herein by reference in its entirety. Further, this application claims priority from Japanese Patent Application No. 2023-087983, filed on May 29, 2023, the disclosure of which is incorporated herein by reference in its entirety.

### BACKGROUND

### 1. Technical Field

The technology of the present disclosure relates to a mirror device and an optical scanning device.

### 2. Description of the Related Art

A micromirror device (also referred to as a microscanner) is known as one of micro electro mechanical systems (MEMS) devices manufactured using the silicon (Si) nanofabrication technique. Since the micromirror device is small and has low power consumption, it is expected to have a wide range of applications in laser displays, laser projectors, optical coherence tomography, and the like.

There are various methods for driving the micromirror device, and a piezoelectric drive method using deformation of a piezoelectric material is promising since the generated torque is higher than that in other methods and a high scan angle can be obtained. In particular, in a case where a high scan angle is required, such as in a laser display, a higher scan angle can be obtained by resonantly driving the micromirror device of the piezoelectric drive method.

A general micromirror device used in a laser display includes a mirror portion and a piezoelectric driving unit (for example, see WO2022/025012A). The mirror portion is swingable around a first axis and a second axis that are orthogonal to each other. The driving unit causes the mirror portion to swing around the first axis and the second axis in accordance with a driving voltage supplied from the outside.

In a biaxial micromirror device, it is essential to provide an angle sensor in order to detect an angle of a mirror portion around each axis in real time during biaxial driving. In the micromirror device using a piezoelectric actuator, a piezoelectric sensor is used as an angle sensor.

In addition, the micromirror device is provided with a fixed frame surrounding the mirror portion and the driving unit, and a plurality of metal pads are provided on the fixed frame. The driving unit and the piezoelectric sensor are each connected via a metal pad and a metal wire.

### SUMMARY

In the biaxial micromirror device, the piezoelectric sensor generates a signal corresponding to the swing of the mirror portion around the first axis or the second axis. However, the signal output from the piezoelectric sensor may include a large amount of noise (hereinafter, referred to as cross-axis noise) caused by the swing around the other axis different from the axis of the detection target. In order to remove such noise, as described in WO2022/025012A, it is considered to reduce the cross-axis noise by performing signal processing based on the output signals of the plurality of piezoelectric sensors.

However, the present applicant has found that the above-described signal processing may not be able to sufficiently reduce the cross-axis noise. Specifically, a swing component in a diagonal direction intersecting the first axis and the second axis may be generated depending on the disposition or the shape of the metal wire. In this case, in the signal processing, the cross-axis noise cannot be sufficiently reduced.

An object of the technology of the present disclosure is to provide a mirror device and an optical scanning device that can reduce cross-axis noise.

In order to achieve the above object, a mirror device according to the present disclosure comprises a mirror portion that has a reflecting surface for reflecting incident light, a pair of first support portions that are connected to the mirror portion on a first axis located in a plane including the reflecting surface in a stationary state of the mirror portion and that swingably support the mirror portion around the first axis, a pair of movable frames that are connected to the pair of first support portions and disposed to face each other across the first axis, a pair of second support portions that are connected to the pair of movable frames on a second axis that is located in the plane and intersects the first axis and that swingably support the mirror portion, the pair of first support portions, and the pair of movable frames around the second axis, a driving unit that is disposed to surround the pair of movable frames and that has a plurality of piezoelectric actuators disposed to face each other across the first axis or the second axis, a fixed frame that is disposed to surround the driving unit, a pair of connecting portions that have a thickness smaller than a thickness of the fixed frame and that extend along the first axis or the second axis to connect the driving unit and the fixed frame to each other, a piezoelectric sensor that generates a signal corresponding to swinging of the mirror portion around the first axis or the second axis, a plurality of metal pads that are formed on the fixed frame, and a plurality of metal wires that electrically connect the piezoelectric actuators and the piezoelectric sensor to the plurality of metal pads, in which the plurality of metal wires have a shape and a position that are line-symmetrical about the first axis or the second axis except for a contact region in contact with the piezoelectric actuator or the piezoelectric sensor.

It is preferable that the driving unit includes a first actuator that is disposed to surround the pair of movable frames and that is formed of a pair of the piezoelectric actuators facing each other across the second axis, and a second actuator that is disposed to surround the first actuator and that is formed of a pair of the piezoelectric actuators facing each other across the first axis.

It is preferable that the piezoelectric actuator and the piezoelectric sensor are each formed of an upper electrode, a piezoelectric film, and a lower electrode, and each of the plurality of metal wires is connected to the upper electrode or the lower electrode.

It is preferable that at least one of the plurality of metal wires is formed of three or more kinds of metal materials.

It is preferable that at least one of the plurality of metal wires is formed by connecting a first wire formed of Au and a second wire formed of Al and Ti.

It is preferable that the pair of connecting portions are disposed on the second axis.

An optical scanning device according to the present disclosure comprises the mirror device described above, and a processor, in which the processor causes the mirror portion to swing around the first axis and the second axis by applying a drive signal to each of the plurality of piezoelectric actuators.

According to the technology of the present disclosure, it is possible to provide a mirror device and an optical scanning device that can reduce the cross-axis noise.

### BRIEF DESCRIPTION OF THE DRAWINGS

Exemplary embodiments according to the technique of the present disclosure will be described in detail based on the following figures, wherein:

FIG. 1 is a schematic view of an optical scanning device,

FIG. 2 is a block diagram showing an example of a hardware configuration of a driving controller,

FIG. 3 is an external perspective view of a micromirror device,

FIG. 4 is a plan view of the micromirror device as viewed from the light incident side,

FIG. 5 is a cross-sectional view taken along the line A-A of FIG. 4,

FIG. 6 is a cross-sectional view showing a state where a mirror portion rotates around a first axis,

FIGS. 7A and 7B are diagrams showing examples of a first drive signal and a second drive signal,

FIG. 8 is a cross-sectional view schematically showing a configuration of a piezoelectric sensor,

FIG. 9 is a plan view showing an example of a layout of a metal pad and a metal wire provided in a micromirror device,

FIG. 10 is a cross-sectional view schematically showing a configuration example of a metal wire,

FIG. 11 is a diagram showing an example of signal processing of generating an angle detection signal,

FIG. 12 is a plan view showing an example of a layout of a metal pad and a metal wire provided in a micromirror device according to a comparative example, and

FIG. 13 is a diagram showing a swing component in a diagonal direction generated in the micromirror device according to the comparative example.

### DETAILED DESCRIPTION

An example of an embodiment according to the technology of the present disclosure will be described with reference to the accompanying drawings.

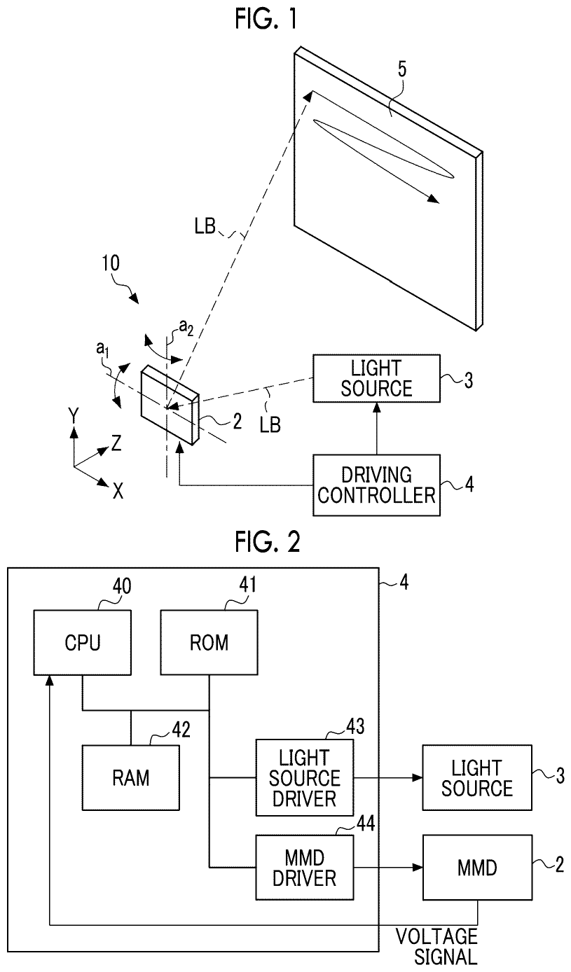

FIG. 1 schematically shows an optical scanning device 10 according to an embodiment. The optical scanning device 10 includes a micromirror device (hereinafter, referred to as MMD) 2, a light source 3, and a driving controller 4. The optical scanning device 10 optically scans a surface to be scanned 5 by reflecting a light beam LB emitted from the light source 3 by the MMD 2 under the control of the driving controller 4. The surface to be scanned 5 is, for example, a screen.

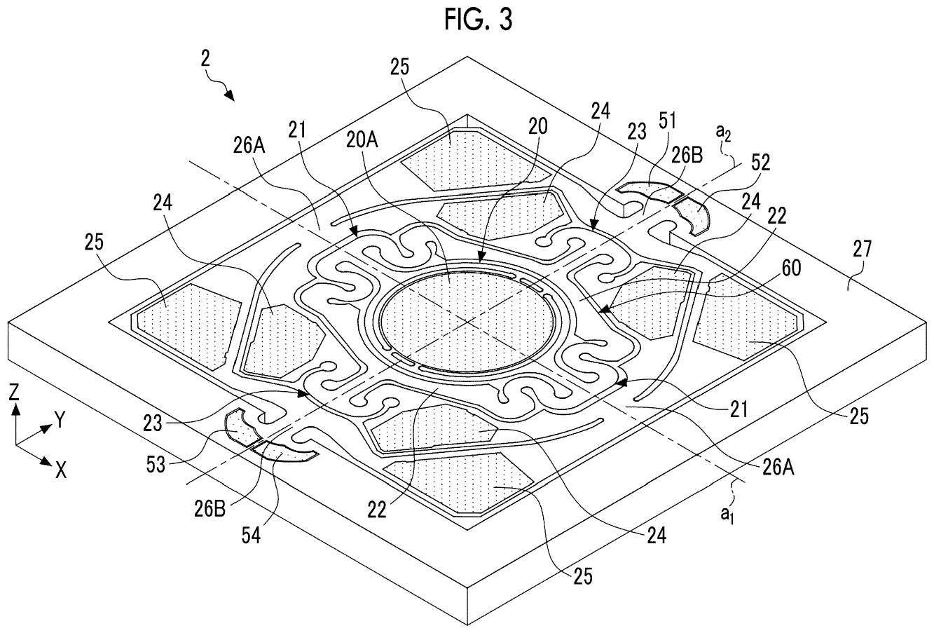

The MMD 2 is a piezoelectric biaxial drive-type micromirror device capable of allowing a mirror portion 20 (see FIG. 3) to swing around a first axis a₁ and a second axis a₂ intersecting the first axis a₁. Hereinafter, a direction parallel to the first axis a₁ is referred to as an X direction, a direction parallel to the second axis a₂ is a Y direction, and a direction orthogonal to the first axis a₁ and the second axis a₂ is referred to as a Z direction. In the present embodiment, the X direction and the Y direction are orthogonal to each other. The MMD 2 is an example of a “mirror device” according to the technology of the present disclosure.

The light source 3 is a laser device that emits, for example, laser light as the light beam LB. It is preferable that the light source 3 emits the light beam LB perpendicularly to a reflecting surface 20A (see FIG. 3) included in the mirror portion 20 in a state where the mirror portion 20 of the MMD 2 is stationary.

The driving controller 4 outputs a drive signal to the light source 3 and the MMD 2 based on optical scanning information. The light source 3 generates the light beam LB based on the input drive signal and emits the light beam LB to the MMD 2. The MMD 2 allows the mirror portion 20 to swing around the first axis a₁ and the second axis a₂ based on the input drive signal.

As will be described in detail below, the driving controller 4 allows the mirror portion 20 to resonate around the first axis a₁ and the second axis a₂, respectively, so that the surface to be scanned 5 is scanned with the light beam LB reflected by the mirror portion 20 such that a Lissajous waveform is drawn. This optical scanning method is called a Lissajous scanning method.

The optical scanning device 10 is applied to, for example, a Lissajous scanning type laser display. Specifically, the optical scanning device 10 can be applied to a laser scanning display such as augmented reality (AR) glass or virtual reality (VR) glass.

FIG. 2 shows an example of a hardware configuration of the driving controller 4. The driving controller 4 has a central processing unit (CPU) 40, a read only memory (ROM) 41, a random access memory (RAM) 42, a light source driver 43, and an MMD driver 44. The CPU 40 is an arithmetic unit that realizes the entire function of the driving controller 4 by reading out a program and data from a storage device such as the ROM 41 into the RAM 42 and executing processing. The CPU 40 is an example of a “processor” according to the technology of the present disclosure.

The ROM 41 is a non-volatile storage device and stores a program for the CPU 40 to execute processing and data such as the optical scanning information described above. The RAM 42 is a volatile storage device that temporarily holds a program and data.

The light source driver 43 is an electric circuit that outputs a drive signal to the light source 3 under the control of the CPU 40. In the light source driver 43, the drive signal is a driving voltage for controlling the irradiation timing and the irradiation intensity of the light source 3.

The MMD driver 44 is an electric circuit that outputs a drive signal to the MMD 2 under the control of the CPU 40. In the MMD driver 44, the drive signal is a driving voltage for controlling the timing, cycle, and deflection angle for allowing the mirror portion 20 of the MMD 2 to swing.

The CPU 40 controls the light source driver 43 and the MMD driver 44 based on the optical scanning information. The optical scanning information is information including the scanning pattern of the light beam LB with which the surface to be scanned 5 is scanned and the light emission timing of the light source 3.

In addition, the CPU 40 generates an angle detection signal representing an angle around the first axis a₁ and the second axis a₂ of the mirror portion 20 based on a voltage signal output from each of four piezoelectric sensors 51 to 54 described below, which are provided in the MMD 2. The CPU 40 corrects the drive signal based on the generated angle detection signal.

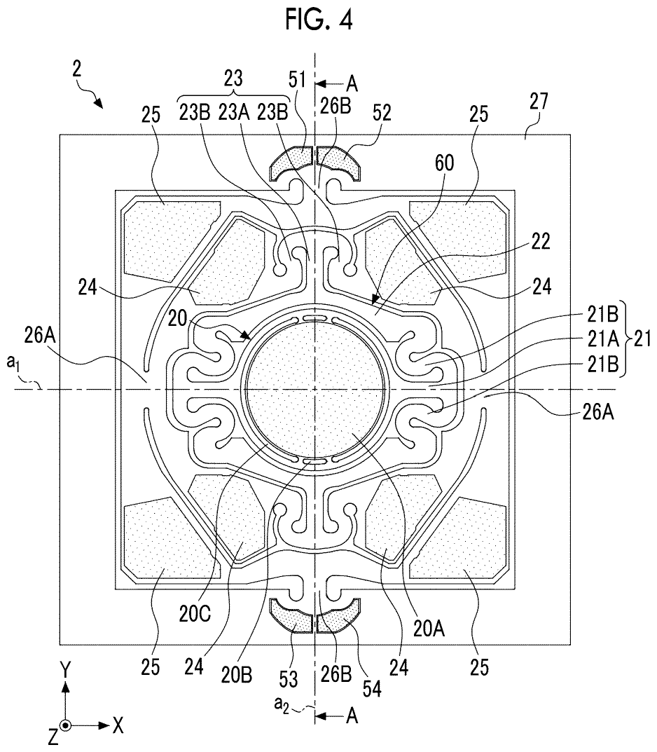

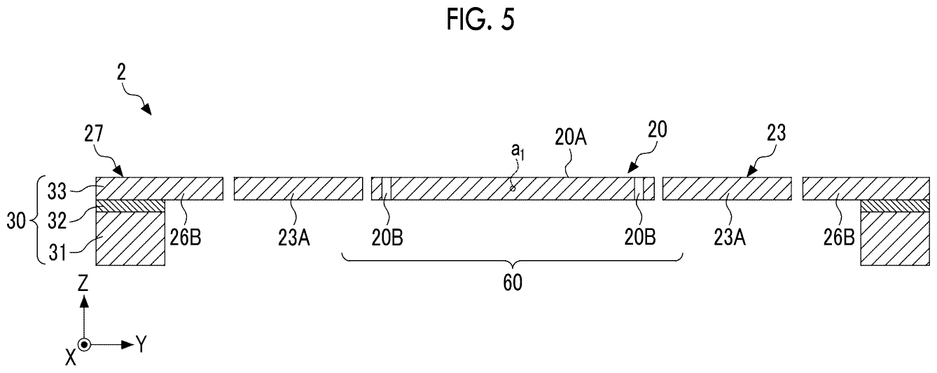

Next, a configuration of the MMD 2 will be described with reference to FIGS. 3 to 5. FIG. 3 is an external perspective view of the MMD 2. FIG. 4 is a plan view of the MMD 2 as viewed from the light incident side. FIG. 5 is a cross-sectional view taken along the line A-A in FIG. 4.

As shown in FIG. 3, the MMD 2 has the mirror portion 20, a pair of first support portions 21, a pair of movable frames 22, a pair of second support portions 23, a first actuator 24, a second actuator 25, a pair of first connecting portions 26A, a pair of second connecting portions 26B, and a fixed frame 27. The MMD 2 is a so-called MEMS scanner.

The mirror portion 20 has a reflecting surface 20A for reflecting incident light. The reflecting surface 20A is provided on one surface of the mirror portion 20, and is formed of a metal thin film such as gold (Au) and aluminum (Al). The shape of the reflecting surface 20A is, for example, circular with the intersection of the first axis a₁ and the second axis a₂ as the center.

The first axis a₁ and the second axis a₂ exist, for example, in a plane including the reflecting surface 20A in a case where the mirror portion 20 is stationary. The planar shape of the MMD 2 is rectangular, line-symmetrical about the first axis a₁, and line-symmetrical about the second axis a₂.

The pair of first support portions 21 are disposed at positions facing each other across the second axis a₂, and have a shape that is line-symmetrical about the second axis a₂. In addition, each of the first support portions 21 has a shape that is line-symmetrical about the first axis a₁. Each of the first support portions 21 is connected to the mirror portion 20 on the first axis a₁, and swingably supports the mirror portion 20 around the first axis a₁.

The pair of movable frames 22 are disposed at positions facing each other across the first axis a₁, and have a shape that is line-symmetrical about the first axis a₁. Each of the movable frames 22 has a shape that is line-symmetrical about the second axis a₂. In addition, each of the movable frames 22 is curved along the outer periphery of the mirror portion 20. Both ends of each of the movable frames 22 are connected to the pair of first support portions 21.

The pair of first support portions 21 and the pair of movable frames 22 are connected to each other to surround the mirror portion 20. The mirror portion 20, the pair of first support portions 21, and the pair of movable frames 22 constitute a movable portion 60.

The pair of second support portions 23 are disposed at positions facing each other across the first axis a₁, and have a shape that is line-symmetrical about the first axis a₁. Each of the second support portions 23 has a shape that is line-symmetrical about the second axis a₂. Each of the second support portions 23 is connected to the movable frame 22 on the second axis a₂, and swingably supports the movable portion 60 having the mirror portion 20 around the second axis a₂. In addition, both ends of each of the second support portions 23 are connected to the first actuator 24.

The first actuator 24 includes a pair of piezoelectric actuators facing each other across the second axis a₂, and has a shape that is line-symmetrical about the second axis a₂. In addition, the first actuator 24 has a shape that is line-symmetrical about the first axis a₁. The first actuator 24 is disposed along the outer periphery of the pair of movable frames 22 and the pair of first support portions 21.

In FIGS. 3 and 4, the piezoelectric actuators constituting the first actuator 24 appear to be separated across the first axis a₁, but the two piezoelectric actuators facing each other across the first axis a₁ are electrically connected by a metal wire (not shown).

The pair of second support portions 23 and the first actuator 24 are connected to each other to surround the movable portion 60.

The second actuator 25 is composed of a pair of piezoelectric actuators facing each other across the first axis a₁, and has a shape that is line-symmetrical about the first axis a₁. In addition, the second actuator 25 has a shape that is line-symmetrical about the second axis a₂. The second actuator 25 is disposed along the outer periphery of the first actuator 24 and the pair of second support portions 23.

In FIGS. 3 and 4, the piezoelectric actuators constituting the second actuator 25 appear to be separated across the second axis a₂, but the two piezoelectric actuators facing each other across the second axis a₂ are electrically connected by a metal wire (not shown).

The pair of first connecting portions 26A are disposed at positions facing each other across the second axis a₂, and have a shape that is line-symmetrical about the second axis a₂. In addition, each of the first connecting portions 26A has a shape that is line-symmetrical about the first axis a₁. Each of the first connecting portions 26A is disposed along the first axis a₁, and connects the first actuator 24 and the second actuator 25 on the first axis a₁.

The pair of second connecting portions 26B are disposed at positions facing each other across the first axis a₁, and have a shape that is line-symmetrical about the first axis a₁. In addition, each of the second connecting portions 26B is stretched in the Y direction, and has a shape that is line-symmetrical about the second axis a₂. Each of the second connecting portions 26B is disposed along the second axis a₂, and connects the second actuator 25 and the fixed frame 27 on the second axis a₂. The pair of second connecting portions 26B are an example of a “pair of connecting portions” according to the technology of the present disclosure.

The second actuator 25 and the pair of second connecting portions 26B are connected to each other to surround the pair of movable portions 60 and the first actuator 24. The first actuator 24 and the second actuator 25 form a driving unit disposed to surround the pair of movable frames 22. That is, the driving unit has a plurality of piezoelectric actuators disposed to face each other across the first axis a₁ or the second axis a₂.

The fixed frame 27 is a frame-shaped member having a rectangular outer shape, and has a shape that is line-symmetrical about the first axis a₁ and the second axis a₂. The fixed frame 27 surrounds the outer periphery of the second actuator 25 and the pair of second connecting portions 26B. That is, the fixed frame 27 surrounds the driving unit.

The first actuator 24 allows the movable portion 60 to swing around the second axis a₂ by applying rotational torque around the second axis a₂ to the mirror portion 20 and the pair of movable frames 22. The second actuator 25 allows the mirror portion 20 to swing around the first axis a₁ by applying rotational torque around the first axis a₁ to the mirror portion 20, the pair of movable frames 22, and the first actuator 24.

As shown in FIG. 4, each of the first support portions 21 is composed of a swing shaft 21A and a pair of coupling parts 21B. The swing shaft 21A is a so-called torsion bar stretched along the first axis a₁. One end of the swing shaft 21A is connected to the mirror portion 20, and the other end thereof is connected to the pair of coupling parts 21B.

The pair of coupling parts 21B are disposed at positions facing each other across the first axis a₁, and have a shape that is line-symmetrical about the first axis a₁. Each of the coupling parts 21B has one end connected to the swing shaft 21A and the other end connected to the movable frame 22. Each of the coupling parts 21B has a folded structure. Since each of the coupling parts 21B has elasticity due to the folded structure, the internal stress applied to the swing shaft 21A is relaxed in a case where the mirror portion 20 swings around the first axis a₁.

Each of the second support portions 23 includes a swing shaft 23A and a pair of coupling parts 23B. The swing shaft 23A is a so-called torsion bar extended along the second axis a₂. One end of the swing shaft 23A is connected to the movable frame 22, and the other end thereof is connected to the pair of coupling parts 23B.

The pair of coupling parts 23B are disposed at positions facing each other across the second axis a₂, and have a shape that is line-symmetrical about the second axis a₂. Each of the coupling parts 23B has one end connected to the swing shaft 23A and the other end connected to the first actuator 24. Each of the coupling parts 23B has a folded structure. Since each of the coupling parts 23B has elasticity due to the folded structure, the internal stress applied to the swing shaft 23A is relaxed in a case where the mirror portion 20 swings around the second axis a₂.

In the mirror portion 20, a plurality of slits 20B and 20C are formed on the outside of the reflecting surface 20A along the outer periphery of the reflecting surface 20A. The plurality of slits 20B and 20C are disposed at positions that are line-symmetrical about the first axis a₁ and the second axis a₂, respectively. The slits 20B and 20C have an effect of suppressing distortion generated on the reflecting surface 20A due to the swing of the mirror portion 20.

Four piezoelectric sensors 51 to 54 are provided in the vicinity of the pair of second connecting portions 26B as an angle sensor for detecting an angle of the mirror portion 20. The piezoelectric sensors 51 to 54, similarly to the first actuator 24 and the second actuator 25, are formed of a piezoelectric element. The piezoelectric sensors 51 to 54 are in a line-symmetrical relationship with respect to the first axis a₁ and the second axis a₂. Specifically, the piezoelectric sensors 51 and 52 are disposed in the vicinity of one of the pair of second connecting portions 26B, and have a line-symmetrical relationship in position and shape about the second axis a₂. The piezoelectric sensors 53 and 54 are disposed in the vicinity of the other of the pair of second connecting portions 26B, and have a line-symmetrical relationship in position and shape about the second axis a₂. The piezoelectric sensors 51 and 52 and the piezoelectric sensors 53 and 54 have a line-symmetrical relationship in position and shape about the first axis a₁.

In FIGS. 3 and 4, the metal wires and the metal pads for applying the drive signals to the first actuator 24 and the second actuator 25 are not shown. In addition, the metal wires and the metal pads for acquiring the voltage signals output from the piezoelectric sensors 51 to 54 are also not shown. A plurality of metal pads are provided on the fixed frame 27. The metal pad is also referred to as an electrode pad.

As shown in FIG. 5, the MMD 2 is formed, for example, by performing an etching treatment on a silicon on insulator (SOI) substrate 30. The SOI substrate 30 is a substrate in which a silicon oxide layer 32 is provided on a first silicon active layer 31 made of single crystal silicon, and a second silicon active layer 33 made of single crystal silicon is provided on the silicon oxide layer 32.

The mirror portion 20, the pair of first support portions 21, the pair of movable frames 22, the pair of second support portions 23, the first actuator 24, the second actuator 25, the pair of first connecting portions 26A, and the pair of second connecting portions 26B are formed of the second silicon active layer 33 remaining after removing the first silicon active layer 31 and the silicon oxide layer 32 from the SOI substrate 30 by an etching treatment. The second silicon active layer 33 functions as an elastic portion having elasticity. The fixed frame 27 is formed of three layers of the first silicon active layer 31, the silicon oxide layer 32, and the second silicon active layer 33. That is, the mirror portion 20, the pair of first support portions 21, the pair of movable frames 22, the pair of second support portions 23, the first actuator 24, the second actuator 25, the pair of first connecting portions 26A, and the pair of second connecting portions 26B each have a thickness smaller than that of the fixed frame 27. In the present disclosure, the thickness means a width in the Z direction.

The piezoelectric actuator of the first actuator 24 is provided with a piezoelectric element formed on the second silicon active layer 33. The piezoelectric element has a laminated structure in which a lower electrode, a piezoelectric film, and an upper electrode are sequentially laminated on the second silicon active layer 33. The second actuator 25 has the same configuration as the first actuator 24.

The lower electrode and the upper electrode are formed of, for example, metal such as gold (Au) or platinum (Pt). The piezoelectric film is formed of, for example, lead zirconate titanate (PZT), which is a piezoelectric material. The lower electrode and the upper electrode are electrically connected to the driving controller 4 described above via the wire and the electrode pad.

The lower electrode is connected to the driving controller 4 via the wire and the electrode pad, and a ground potential is applied thereto. A driving voltage is applied to the upper electrode from the driving controller 4.

In a case where a positive or negative voltage is applied to the piezoelectric film in the polarization direction, deformation (for example, expansion and contraction) proportional to the applied voltage occurs. That is, the piezoelectric film exerts a so-called inverse piezoelectric effect. The piezoelectric film exerts an inverse piezoelectric effect by applying a driving voltage from the driving controller 4 to the upper electrode, and displaces the first actuator 24 and the second actuator 25.

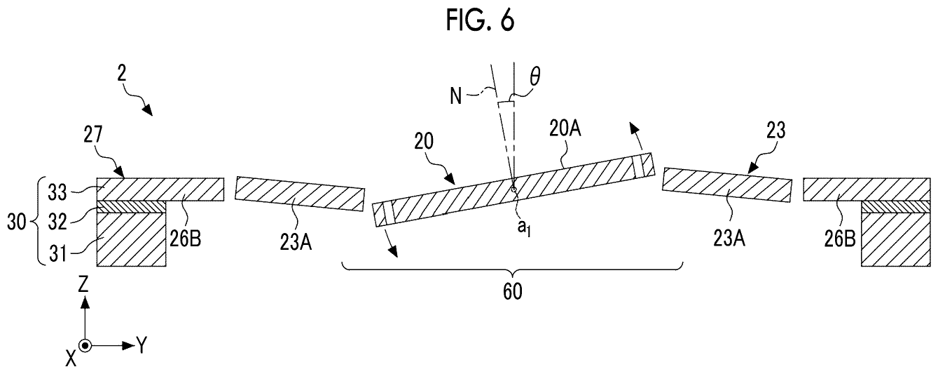

FIG. 6 shows an example in which one of the pair of piezoelectric actuators constituting the second actuator 25 is expanded and the other is contracted to generate the rotational torque around the first axis a₁ in the second actuator 25. In this way, one of the pair of piezoelectric actuators and the other are displaced in opposite directions to each other, thereby the mirror portion 20 rotates around the first axis a₁.

In addition, FIG. 6 shows an example in which the second actuator 25 is driven in an anti-phase resonance mode (hereinafter, referred to as an anti-phase rotation mode) in which the displacement direction of the pair of piezoelectric actuators and the rotation direction of the mirror portion 20 are opposite to each other. On the other hand, an in-phase resonance mode in which the displacement direction of the pair of piezoelectric actuators and the rotation direction of the mirror portion 20 are the same direction is called an in-phase rotation mode. In the present embodiment, the second actuator 25 is driven in the anti-phase rotation mode.

A deflection angle θ of the mirror portion 20 around the first axis a₁ is controlled by the drive signal (hereinafter, referred to as a first drive signal) given to the second actuator 25 by the driving controller 4. The first drive signal is, for example, a sinusoidal AC voltage. The first drive signal includes a driving voltage waveform V_{1A} (t) applied to one of the pair of piezoelectric actuators and a driving voltage waveform V_{1B} (t) applied to the other. The driving voltage waveform V_{1A} (t) and the driving voltage waveform V_{1B} (t) are in an anti-phase with each other (that is, the phase difference is 180°).

The deflection angle θ of the mirror portion 20 around the first axis a corresponds to an angle at which the normal line N of the reflecting surface 20A is inclined with respect to the Z direction in the YZ plane.

The first actuator 24 is driven in an anti-phase resonance mode in the same manner as the second actuator 25. A deflection angle of the mirror portion 20 around the second axis a₂ is controlled by the drive signal (hereinafter, referred to as a second drive signal) given to the first actuator 24 by the driving controller 4. The second drive signal is, for example, a sinusoidal AC voltage. The second drive signal includes a driving voltage waveform V_{2A} (t) applied to one of the pair of piezoelectric actuators and a driving voltage waveform V_{2B} (t) applied to the other. The driving voltage waveform V_{2A} (t) and the driving voltage waveform V_{2B} (t) are in an anti-phase with each other (that is, the phase difference is 180°).

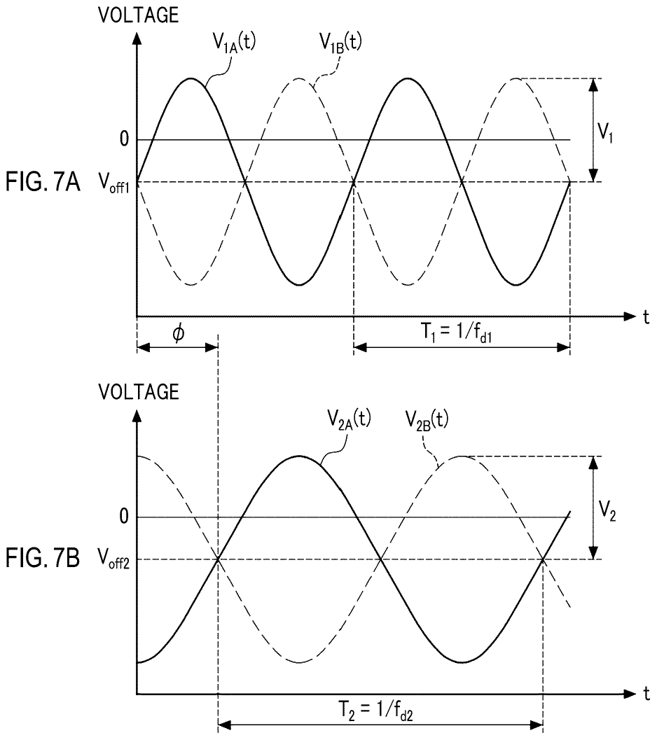

FIGS. 7A and 7B show examples of the first drive signal and the second drive signal. FIG. 7A shows the driving voltage waveforms V_{1A} (t) and V_{1B} (t) included in the first drive signal. FIG. 7B shows the driving voltage waveforms V_{2A} (t) and V_{2B} (t) included in the second drive signal.

The driving voltage waveforms V_{1A} (t) and V_{1B} (t) are represented as follows, respectively.

$${V}_{1 A} ( t ) = {V}_{off 1} + {V}_{1} sin ( 2 π {f}_{d 1} t )$$

$${V}_{1 B} ( t ) = {V}_{off 1} + {V}_{1} sin ( 2 π {f}_{d 1} t + α )$$

Here, V₁ is the amplitude voltage. V_{off1} is the bias voltage. f_{d1} is the driving frequency (hereinafter, referred to as the first driving frequency). t is time. α is the phase difference between the driving voltage waveforms V_{1A} (t) and V_{1B} (t). In the present embodiment, for example, α=180°.

By applying the driving voltage waveforms V_{1A} (t) and V_{1B} (t) to the second actuator 25, the mirror portion 20 swings around the first axis a₁ at the first driving frequency f_{d1}.

The driving voltage waveforms V_{2A} (t) and V_{2B} (t) are represented as follows, respectively.

$${V}_{2 A} ( t ) = {V}_{off 2} + {V}_{2} sin ( 2 π {f}_{d 2} t + φ )$$

$${V}_{2 B} ( t ) = {V}_{off 2} + {V}_{2} sin ( 2 π {f}_{d 2} t + β + φ )$$

Here, V₂ is the amplitude voltage. V_{off2} is the bias voltage. f_{d2} is the driving frequency (hereinafter, referred to as the second driving frequency). t is time. β is the phase difference between the driving voltage waveforms V_{2A} (t) and V_{2B} (t). In the present embodiment, for example, β=180°. In addition, q is the phase difference between the driving voltage waveforms V_{1A} (t) and V_{1B} (t) and the driving voltage waveforms V_{2A} (t) and V_{2B} (t). In the present embodiment, for example, V_{off1}=V_{off2}=0 V.

By applying the driving voltage waveforms V_{2A} (t) and V_{2B} (t) to the first actuator 24, the movable portion 60 including the mirror portion 20 swings around the second axis a₂ at the second driving frequency f_{d2}.

The first driving frequency f_{d1} is set so as to match the resonance frequency around the first axis a₁ of the mirror portion 20. The second driving frequency f_{d2} is set so as to match the resonance frequency around the second axis a₂ of the mirror portion 20. In the present embodiment, the first driving frequency f_{d1} is larger than the second driving frequency f_{d2}.

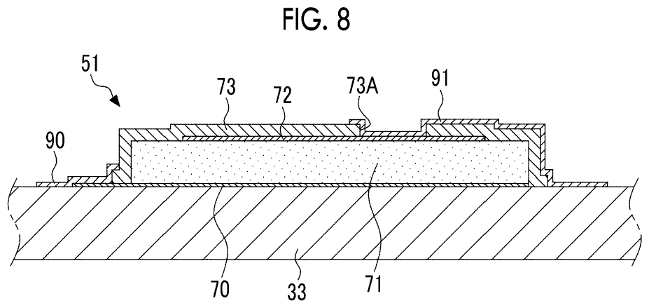

FIG. 8 schematically shows a configuration of the piezoelectric sensor 51. The piezoelectric sensor 51 includes a lower electrode 70, a piezoelectric film 71, and an upper electrode 72. The lower electrode 70, the piezoelectric film 71, and the upper electrode 72 are sequentially laminated on the second silicon active layer 33. The lower electrode 70 and the upper electrode 72 are formed of, for example, a metal such as gold (Au) or platinum (Pt). The piezoelectric film 71 is formed of, for example, lead zirconate titanate (PZT), which is a piezoelectric material.

The upper electrode 72 is covered with an insulating film 73. The insulating film 73 is formed with an opening 73A through which a part of the upper electrode 72 is exposed. The metal wire 91 formed of a metal is provided on the insulating film 73. The metal wire 91 is connected to the upper electrode 72 via the opening 73A. The lower electrode 70 is connected to a metal wire 90 formed on the second silicon active layer 33. A ground potential is applied to the metal wire 90.

The lower electrode 70, the piezoelectric film 71, and the upper electrode 72 are manufactured by the same manufacturing process as the lower electrode, the piezoelectric film, and the upper electrode of the piezoelectric actuators constituting the first actuator 24 and the second actuator 25.

The piezoelectric film 71 converts the stress applied in a case where the mirror portion 20 swings into a voltage signal by a piezoelectric effect. As a result, a voltage signal corresponding to the angle of the mirror portion 20 is acquired from the upper electrode 72.

The piezoelectric sensors 52 to 54 have the same configuration as the piezoelectric sensor 51. The piezoelectric actuator also has the same configuration as the piezoelectric sensor 51.

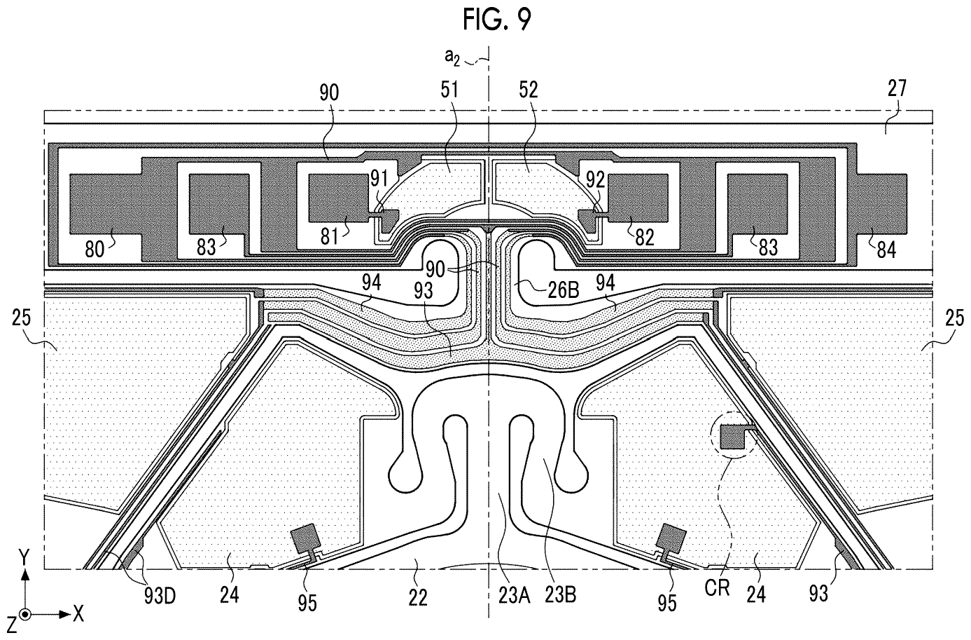

FIG. 9 shows an example of a layout of a metal pad and a metal wire provided in the MMD 2. FIG. 9 is a partially enlarged view of a region including the piezoelectric sensors 51 and 52.

A plurality of metal pads 80 to 84 are formed on the fixed frame 27. The metal pad 80 is an electrode pad for applying a ground potential, and the metal wire 90 is connected to the metal pad 80. The metal wire 90 is connected to the lower electrodes of the piezoelectric actuators constituting the first actuator 24 and the second actuator 25 and the lower electrodes of the piezoelectric sensors 51 to 54.

The metal pad 81 is an electrode pad for acquiring a voltage signal from the piezoelectric sensor 51, and the above-described metal wire 91 is connected to the metal pad 81. Similarly, the metal pad 82 is an electrode pad for acquiring a voltage signal from the piezoelectric sensor 52, and the metal wire 92 is connected to the metal pad 82.

The metal pad 83 is an electrode pad for applying a second drive signal to the first actuator 24, and the metal wire 93 is connected to the metal pad 83. The metal wire 93 is connected to an upper electrode of the piezoelectric actuator constituting the first actuator 24. The pair of metal pads 83 are provided on the fixed frame 27 at positions facing each other across the second axis a₂, and the pair of metal pads 83 are electrically connected to each other via the metal wire 93.

The metal pad 84 is an electrode pad for applying the first drive signal to the second actuator 25, and the metal wire 94 is connected to the metal pad 84. The metal wire 94 is connected to an upper electrode of the piezoelectric actuator constituting the second actuator 25.

The metal wires 90, 93, and 94 are wired from the fixed frame 27 through the second connecting portion 26B to the region where the second actuator 25 is formed. In addition, although not shown in FIG. 9, the metal wires 90 and 93 are further wired from the second actuator 25 to the first actuator 24 through the first connecting portion 26A.

In addition, metal wires 95 and 93D are formed in the MMD 2. The metal wire 95 is included in each of the first actuators 24 and connects upper electrodes of two piezoelectric actuators facing each other across the second axis a₂. The metal wire 93D is a dummy wire formed at a position that is line-symmetrical with respect to the metal wire 93 about the second axis a₂ and is electrically isolated.

In the technology of the present disclosure, the plurality of metal wires have a shape and a position that are line-symmetrical about the first axis a₁ or the second axis a₂ except for a contact region in contact with the piezoelectric actuator or the piezoelectric sensor. In the example shown in FIG. 9, the plurality of metal wires 90 to 94 have the same shape and position as each other in a line-symmetrical manner about the second axis a₂ except for a contact region CR where the metal wire 93 is in contact with the piezoelectric actuator. The metal wire 93 is configured such that a metal wire 93D as a dummy wire is provided as a part of the metal wire 93 and the shape and the position of the metal wire 93 are line-symmetrical about the second axis a₂.

Although not shown, the layout of the plurality of metal pads and the plurality of metal wires is the same as that in FIG. 9 even in the region including the piezoelectric sensors 53 and 54. In the present embodiment, the plurality of metal pads and the plurality of metal wires are formed to be rotationally symmetric with respect to 180° about an intersection between the first axis a₁ and the second axis a₂. That is, the plurality of metal wires are line-symmetrical about the first axis a₁ and line-symmetrical about the second axis a₂.

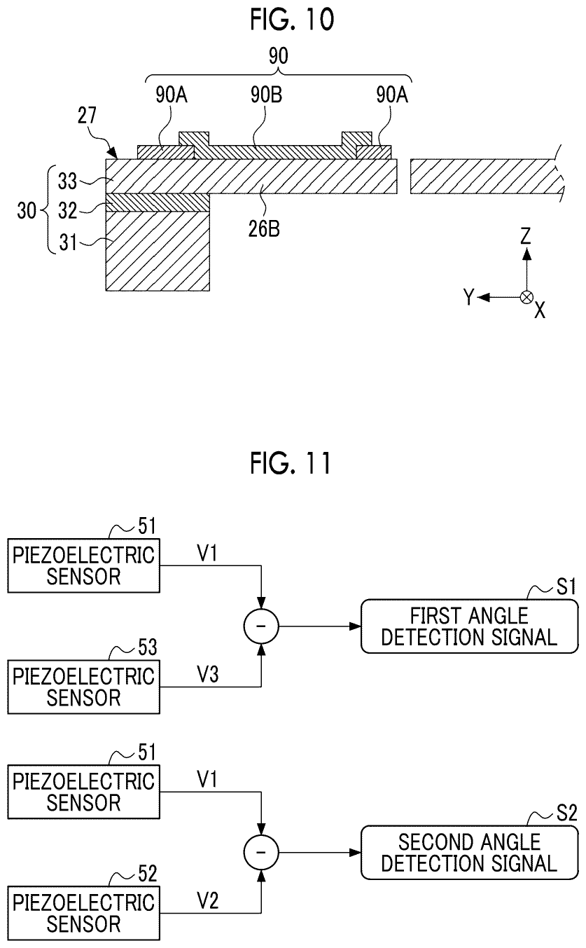

FIG. 10 schematically shows a configuration example of the metal wire 90. The metal wire 90 is configured by connecting a first wire 90A and a second wire 90B. One end of the first wire 90A is connected to the metal pad 80, and the other end thereof is connected to the second wire 90B. Mainly, the first wire 90A is provided in a region (the fixed frame 27 and the like) where the stress applied in a case where the mirror portion 20 swings is small. The second wire 90B is provided in a region (the second connecting portion 26B and the like) where the stress applied in a case where the mirror portion 20 swings is large.

For example, the first wire 90A is formed of gold (Au), and the second wire 90B is formed of aluminum (Al) and titanium (Ti). For example, the second wire 90B is an amorphous metal containing Al and Ti. That is, the metal wire 90 is formed by including three types of metal materials. The metal wire 90 may be formed by including three or more kinds of metal materials.

The metal wires 93 and 94 are configured by connecting the first wire and the second wire, similarly to the metal wire 90. The metal wires 93 and 94 may be formed by including three or more kinds of metal materials.

In the MMD according to the technology of the present disclosure, at least one of the plurality of metal wires is configured by connecting a first wire formed of Au to a second wire formed of Al and Ti. The first wire is integrally formed with the metal pad by the same metal material as the metal pad.

FIG. 11 shows an example of signal processing of generating the angle detection signal by the CPU 40. For example, the CPU 40 generates a first angle detection signal S1 representing an angle of the mirror portion 20 around the first axis a₁ by subtracting a voltage signal V3 obtained from the upper electrode 72 of the piezoelectric sensor 53 from a voltage signal V1 obtained from the upper electrode 72 of the piezoelectric sensor 51. In addition, the CPU 40 generates a second angle detection signal S2 representing an angle of the mirror portion 20 around the second axis a₂ by subtracting a voltage signal V2 obtained from the upper electrode 72 of the piezoelectric sensor 52 from the voltage signal V1 obtained from the upper electrode 72 of the piezoelectric sensor 51.

Signal components (detection target components) around the first axis a₁ included in the voltage signal V1 and the voltage signal V3 are in an anti-phase with each other. On the other hand, signal components (noise components) around the second axis a₂ included in the voltage signal V1 and the voltage signal V3 are in-phase with each other. Therefore, by subtracting the voltage signal V3 from the voltage signal V1, the detection target component is amplified, and the cross-axis noise, which is a signal component around the other axis other than the detection target, is reduced.

Signal components (detection target components) around the second axis a₂ included in the voltage signal V1 and the voltage signal V2 are in an anti-phase with each other. On the other hand, signal components (noise components) around the first axis a₁ included in the voltage signal V1 and the voltage signal V2 are in-phase with each other. Therefore, by subtracting the voltage signal V2 from the voltage signal V1, the detection target component is amplified, and the cross-axis noise, which is a signal component around the other axis other than the detection target, is reduced.

The present applicant has found that, in a case where the shape and position of the plurality of metal wires are not line-symmetrical about the first axis a₁ or the second axis a₂, the swing component in the diagonal direction intersecting the first axis and the second axis increases, and in the above-described signal processing, the cross-axis noise may not be sufficiently reduced.

In the MMD according to the technology of the present disclosure, the shapes and positions of the plurality of metal wires are line-symmetrical about the first axis a₁ or the second axis a₂ except for a contact region in contact with the piezoelectric actuator or the piezoelectric sensor, and the symmetry is high, so that the generation of the swing component in the diagonal direction is suppressed. Therefore, according to the technology of the present disclosure, since the generation of the swing component in the diagonal direction is suppressed, the cross-axis noise can be reduced by the above-described signal processing.

Furthermore, the technology of the present disclosure can suppress “abnormal oscillation” described below. In the MMD according to the comparative examples described below, a resonance mode in the diagonal direction, which has a resonance frequency different from the resonance frequency of the resonance mode of the drive target, is weakly excited by the swing component in the diagonal direction. The superposition of the resonance mode in the diagonal direction and the resonance mode of the drive target causes the displacement in each part of the MMD to exhibit beating. The beating has a frequency component corresponding to the difference between the resonance frequencies of the two resonance modes, but the frequency component further coincides with the frequency component of the other resonance modes, so that a plurality of resonance modes may be excited at the same time (that is, abnormal oscillation occurs). In a case where this abnormal oscillation occurs, the drawing performance of the MMD is significantly deteriorated. The ease of excitation of each resonance mode increases as the symmetry of the displacement component causing the resonance matches the symmetry of the resonance mode to be excited. Therefore, according to the technology of the present disclosure, since the generation of the swing component in the diagonal direction is suppressed, abnormal oscillation can be suppressed.

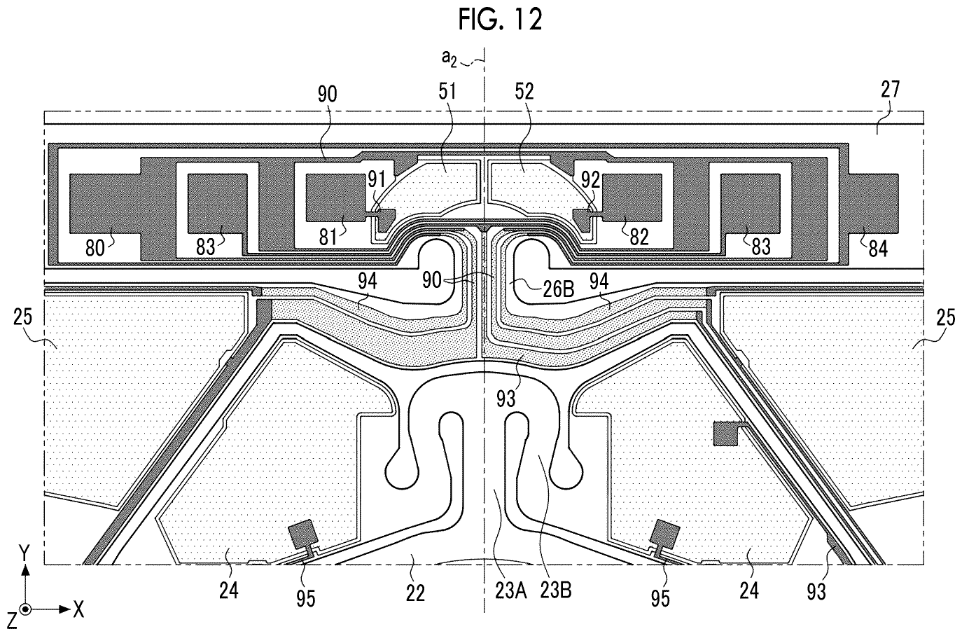

FIG. 12 shows an example of a layout of a metal pad and a metal wire provided in the MMD according to the comparative example. The MMD according to the comparative example is different from the MMD 2 according to the above-described embodiment only in the shapes and positions of the metal wires 90 and 93. As shown in FIG. 12, in the MMD according to the comparative example, the metal wires 90 and 93 do not have a line-symmetrical shape about the second axis a₂. The metal wire 90 has different thicknesses on the left and right sides with respect to the second axis a₂. In addition, in the MMD according to the comparative example, since the metal wire 93D as the dummy wire is not provided, the metal wire 93 does not have a line-symmetrical shape about the second axis a₂.

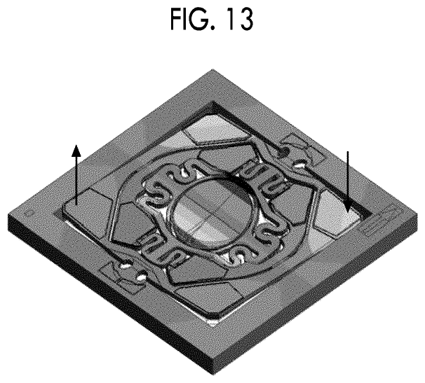

In the MMD according to the comparative example, since the plurality of metal wires are not line-symmetrical about the first axis a₁ or the second axis a₂ and have low symmetry, a swing component in the diagonal direction is generated as shown in FIG. 13. The cross-axis noise caused by the swing component in the diagonal direction cannot be easily reduced by the above-described signal processing. In addition, the swing component in the diagonal direction causes the above-described abnormal oscillation.

The configuration of the MMD 2 according to the above-described embodiment is an example, and various modifications can be made.

In the above-described embodiment, as shown in FIG. 11, the first angle detection signal S1 is generated by subtracting the voltage signal V3 from the voltage signal V1, and the second angle detection signal S2 is generated by subtracting the voltage signal V2 from the voltage signal V1. Alternatively, the first angle detection signal S1 can be generated by adding the voltage signal V1 and the voltage signal V2, and the second angle detection signal S2 can be generated by subtracting the voltage signal V3 from the voltage signal V1. In this way, the first angle detection signal S1 and the second angle detection signal S2 can be generated by adding or subtracting the voltage signals V1 to V4.

In addition, in the above-described embodiment, the lower electrodes of the pair of piezoelectric sensors having a line-symmetrical relationship about the second axis a₂ are connected via the electrode wire as the metal wire. Alternatively, the upper electrodes of the pair of piezoelectric sensors having a line-symmetrical relationship about the second axis a₂ may be connected via the electrode wire as the metal wire. In this case, the angle detection signal can be generated by using the voltage signals obtained from the lower electrodes of the pair of piezoelectric sensors.

Further, in the above-described embodiment, four piezoelectric sensors 51 to 54 are provided, but the number of piezoelectric sensors is not limited to four. In addition, the shape of the piezoelectric sensor and the position where the piezoelectric sensor is disposed can be appropriately changed. For example, the piezoelectric sensor may be provided on the first axis a₁ or the second axis a₂.

In addition, in the above embodiment, the hardware configuration of the driving controller 4 can be variously modified. The processing unit of the driving controller 4 may be provided with one processor or may be provided with a combination of two or more processors of the same type or different types. The processor includes, for example, a CPU, a programmable logic device (PLD), or a dedicated electric circuit. As is well known, the CPU is a general-purpose processor that executes software (program) to function as various processing units. The PLD is a processor such as a field programmable gate array (FPGA) whose circuit configuration can be changed after manufacture. The dedicated electric circuit is a processor that has a dedicated circuit configuration designed to perform a specific process, such as an application specific integrated circuit (ASIC).

The following technology can be understood based on the above description.

### [Supplementary Note 1]

A mirror device comprising:
a mirror portion that has a reflecting surface for reflecting incident light;
a pair of first support portions that are connected to the mirror portion on a first axis located in a plane including the reflecting surface in a stationary state of the mirror portion and that swingably support the mirror portion around the first axis;
a pair of movable frames that are connected to the pair of first support portions and disposed to face each other across the first axis;
a pair of second support portions that are connected to the pair of movable frames on a second axis that is located in the plane and intersects the first axis and that swingably support the mirror portion, the pair of first support portions, and the pair of movable frames around the second axis;
a driving unit that is disposed to surround the pair of movable frames and that has a plurality of piezoelectric actuators disposed to face each other across the first axis or the second axis;
a fixed frame that is disposed to surround the driving unit;
a pair of connecting portions that have a thickness smaller than a thickness of the fixed frame and that extend along the first axis or the second axis to connect the driving unit and the fixed frame to each other;
a piezoelectric sensor that generates a signal corresponding to swinging of the mirror portion around the first axis or the second axis;
a plurality of metal pads that are formed on the fixed frame; and
a plurality of metal wires that electrically connect the piezoelectric actuators and the piezoelectric sensor to the plurality of metal pads,
in which the plurality of metal wires have a shape and a position that are line-symmetrical about the first axis or the second axis except for a contact region in contact with the piezoelectric actuator or the piezoelectric sensor.

### [Supplementary Note 2]

The mirror device according to Supplementary Note 1,
in which the driving unit includes
   a first actuator that is disposed to surround the pair of movable frames and that is formed of a pair of the piezoelectric actuators facing each other across the second axis, and
   a second actuator that is disposed to surround the first actuator and that is formed of a pair of the piezoelectric actuators facing each other across the first axis.

### [Supplementary Note 3]

The mirror device according to Supplementary Notes 1 or 2,
in which the piezoelectric actuator and the piezoelectric sensor are each formed of an upper electrode, a piezoelectric film, and a lower electrode, and
each of the plurality of metal wires is connected to the upper electrode or the lower electrode.

### [Supplementary Note 4]

The mirror device according to any one of Supplementary Notes 1 to 3,
in which at least one of the plurality of metal wires is formed of three or more kinds of metal materials.

### [Supplementary Note 5]

The mirror device according to Supplementary Note 4, in which at least one of the plurality of metal wires is formed by connecting a first wire formed of Au and a second wire formed of Al and Ti.

### [Supplementary Note 6]

The mirror device according to any one of Supplementary Notes 1 to 5, in which the pair of connecting portions are disposed on the second axis.

### [Supplementary Note 7]

An optical scanning device comprising:
the mirror device according to any one of Supplementary Notes 1 to 6; and
a processor,
in which the processor causes the mirror portion to swing around the first axis and the second axis by applying a drive signal to each of the plurality of piezoelectric actuators.

What is claimed is:

1. A mirror device comprising:
a mirror portion that has a reflecting surface for reflecting incident light;
a pair of first support portions that are connected to the mirror portion on a first axis located in a plane including the reflecting surface in a stationary state of the mirror portion and that swingably support the mirror portion around the first axis;
a pair of movable frames that are connected to the pair of first support portions and disposed to face each other across the first axis;
a pair of second support portions that are connected to the pair of movable frames on a second axis that is located in the plane and intersects the first axis and that swingably support the mirror portion, the pair of first support portions, and the pair of movable frames around the second axis;
a driving unit that is disposed to surround the pair of movable frames and that has a plurality of piezoelectric actuators disposed to face each other across the first axis or the second axis;
a fixed frame that is disposed to surround the driving unit;
a pair of connecting portions that have a thickness smaller than a thickness of the fixed frame and that extend along the first axis or the second axis to connect the driving unit and the fixed frame to each other;
a piezoelectric sensor that generates a signal corresponding to swinging of the mirror portion around the first axis or the second axis;
a plurality of metal pads that are formed on the fixed frame; and
a plurality of metal wires that electrically connect the piezoelectric actuators and the piezoelectric sensor to the plurality of metal pads,
wherein the plurality of metal wires have a shape and a position that are line-symmetrical about the first axis or the second axis except for a contact region in contact with the piezoelectric actuator or the piezoelectric sensor.

2. The mirror device according to claim 1,
wherein the driving unit includes
a first actuator that is disposed to surround the pair of movable frames and that is formed of a pair of the piezoelectric actuators facing each other across the second axis, and
a second actuator that is disposed to surround the first actuator and that is formed of a pair of the piezoelectric actuators facing each other across the first axis.

3. The mirror device according to claim 1,
wherein the piezoelectric actuator and the piezoelectric sensor are each formed of an upper electrode, a piezoelectric film, and a lower electrode, and
each of the plurality of metal wires is connected to the upper electrode or the lower electrode.

4. The mirror device according to claim 1,
wherein at least one of the plurality of metal wires is formed of three or more kinds of metal materials.

5. The mirror device according to claim 4,
wherein at least one of the plurality of metal wires is formed by connecting a first wire formed of Au and a second wire formed of Al and Ti.

6. The mirror device according to claim 1,
wherein the pair of connecting portions are disposed on the second axis.

7. An optical scanning device comprising:
the mirror device according to claim 1; and
a processor,
wherein the processor causes the mirror portion to swing around the first axis and the second axis by applying a drive signal to each of the plurality of piezoelectric actuators.
